(19) United States
(12) Patent Application Publication
(10) Pub. No.: US 2025/0348774 A1
(43) Pub. Date: Nov. 13, 2025

(54) AUTOMATED META-LEARNING IN CLUSTERING USING A MACHINE LEARNING CLUSTERING META LEARNING MODEL

(71) Applicant: International Business Machines Corporation, Armonk, NY (US)

(72) Inventors: Long Vu, Chappaqua, NY (US); Charu C. Aggarwal, Yorktown Heights, NY (US); Horst Cornelius Samulowitz, Armonk, NY (US)

(21) Appl. No.: 18/656,691

(22) Filed: May 7, 2024

(51) Int. Cl. G06N 20/00

(52) U.S. Cl. CPC G06N 20/00

(57) ABSTRACT

A method of creating a machine learning clustering meta learning model for use in solving a machine learning clustering problem includes obtaining a plurality of information related to the machine learning clustering problem, wherein the plurality of information includes classification datasets, machine learning transformers and clustering estimators, creating a set of clustering datasets using the classification datasets, generating trained clustering pipelines by training the set of unsupervised clustering pipelines responsive to the clustering datasets, processing the trained clustering pipelines to generate internal scores and external scores for the set of clustering datasets, creating an encoded clustering pipeline by encoding the trained clustering pipeline using the external score as a label and generating a trained supervised machine learning model by combining the internal scores and the encoded clustering pipelines.

### BACKGROUND

The invention generally relates to clustering of data, and more particularly, to a method of solving a clustering problem by using a machine learning clustering meta-learning model.

Clustering is an unsupervised machine learning method of identifying and grouping similar data points in larger datasets without concern for a specific outcome. Clustering (sometimes called cluster analysis) is usually used to classify data into structures that are more easily understood and manipulated. A problem with most cluster analysis methods is that while the available analysis methods are great at separating data into subsets, the strategies used beyond that point are usually not related to the data itself, but rather to the positioning of the data in relation to other data points of the dataset. Therefore, one of the biggest issues with solving clustering problems includes the problem of clustering the partition data samples into groups of similar data and not simply into groups of data that are relative to other data points of the subset. Currently, however, all of the clustering data problem solution methods attempt to solve clustering problems using an unsupervised approach. Additionally, although different available clustering algorithms work well on different data sets, it remains a difficult task to match a specific clustering algorithm with a specific data set.

### SUMMARY

A method for creating a machine learning clustering meta learning model for use in solving a machine learning clustering problem is provided, where the method includes obtaining a plurality of information related to the machine learning clustering problem, wherein the plurality of information includes classification datasets, machine learning transformers and clustering estimators, creating a set of clustering datasets using the classification datasets and creating a plurality of unsupervised clustering pipelines, generating trained unsupervised clustering pipelines by training the set of unsupervised clustering pipelines responsive to the clustering datasets, processing the trained unsupervised clustering pipelines to generate internal scores and external scores for the set of clustering datasets, creating an encoded clustering pipeline by encoding the trained clustering pipeline using the external score as a label and generating a trained supervised machine learning model by combining the internal scores and the encoded clustering pipelines.

Embodiments of the invention are also directed to computer-implemented methods and computer program products having substantially the same features and functionality as the computer system described above.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 shows a block diagram of an example computer system for use in accordance with one or more embodiments of the present invention.

FIG. 2 shows a table illustrating comparative performance results of the method of the invention relative to existing clustering algorithms, in accordance with one or more embodiments of the present invention.

FIG. 3 is an operational block diagram illustrating a method of creating a machine learning clustering meta learning model for use in solving a machine learning clustering problem, in accordance with one or more embodiments of the present invention.

### DETAILED DESCRIPTION

In an embodiment of the invention, a method of creating a machine learning clustering meta learning model for use in solving a machine learning clustering problem includes obtaining a plurality of information related to the machine learning clustering problem, wherein the plurality of information includes classification datasets, machine learning transformers and clustering estimators, creating a set of clustering datasets using the classification datasets and creating a plurality of unsupervised clustering pipelines and generating trained unsupervised clustering pipelines by training the set of unsupervised clustering pipelines responsive to the clustering datasets. The method further includes processing the trained unsupervised clustering pipelines to generate internal scores and external scores for the set of clustering datasets, creating an encoded clustering pipeline by encoding the trained clustering pipeline using the external score as a label and generating a trained supervised machine learning model by combining the internal scores and the encoded clustering pipelines.

In some examples of the method, the classification datasets include unseen datasets.

In further examples of the method, creating a set of clustering datasets includes creating a repository of labeled datasets, wherein the labeled datasets are used to match a clustering pipeline with a particular labeled dataset.

In yet further examples of the method, processing includes generating a plurality of selected top k clustering pipelines by identifying a plurality of top k clustering pipelines from a plurality of k clustering pipelines.

In yet further examples of the method, processing further includes executing the plurality of selected top k clustering pipelines to obtain the internal scores, wherein the selected top k clustering pipelines are encoded and combined with the internal scores to generate an input to the machine learning clustering meta learning model.

In yet further examples of the method, the internal scores include a silhouette_score, a calinski_harabasz_score and a davies_bouldin_score, and wherein the external scores include a normalized_mutual_info_score, a fowlkes_mallows_score and an adjusted_rand_score.

In yet further examples of the method, generating a trained supervised machine learning model includes generating an encoded trained clustering pipeline by encoding the trained clustering pipeline with the external score as a label and combining the encoded trained clustering pipe with the internal scores.

In another aspect of the invention, a computing system includes a processor configured to perform operations for creating a machine learning clustering meta learning model for use in solving a machine learning clustering problem, where the operations include obtaining a plurality of information related to the machine learning clustering problem, wherein the plurality of information include classification datasets, machine learning transformers and clustering estimators, creating a set of clustering datasets using the classification datasets and creating a plurality of unsupervised clustering pipelines and generating trained unsupervised clustering pipelines by training the set of unsupervised clustering pipelines responsive to the clustering datasets. The operations further include processing the trained unsupervised clustering pipelines to generate internal scores and external scores for the set of clustering datasets, creating an encoded clustering pipeline by encoding the trained clustering pipeline using the external score as a label and generating a trained supervised machine learning model by combining the internal scores and the encoded clustering pipelines.

In some examples of the computing system, the classification datasets include unseen datasets.

In further examples of the computing system, creating a set of clustering datasets includes creating a repository of labeled datasets, wherein the labeled datasets are used to match a clustering pipeline with a particular labeled dataset.

In yet further examples of the computing system, processing includes generating a plurality of selected top k clustering pipelines by identifying a plurality of top k clustering pipelines from a plurality of k clustering pipelines.

In yet further examples of the computing system, processing further includes executing the plurality of selected top k clustering pipelines to obtain the internal scores, wherein the selected top k clustering pipelines are encoded and combined with the internal scores to generate an input to the machine learning clustering meta learning model.

In yet further examples of the computing system, the internal scores include a silhouette_score, a calinski_harabasz_score and a davies_bouldin_score, and wherein the external scores include a normalized_mutual_info_score, a fowlkes_mallows_score and an adjusted_rand_score.

In yet further examples of the computing system, generating a trained supervised machine learning model includes generating an encoded trained clustering pipeline by encoding the trained clustering pipeline with the external score as a label and combining the encoded trained clustering pipe with the internal scores.

Yet another aspect of the invention includes a computer program product including a computer readable storage medium having program instructions embodied therewith, wherein the program instructions are executable by a processor to cause the processor to perform operations for creating a machine learning clustering meta learning model for use in solving a machine learning clustering problem. The operations include obtaining a plurality of information related to the machine learning clustering problem, wherein the plurality of information includes classification datasets, machine learning transformers and clustering estimators, creating a set of clustering datasets using the classification datasets and creating a plurality of unsupervised clustering pipelines and generating trained unsupervised clustering pipelines by training the set of unsupervised clustering pipelines responsive to the clustering datasets. The operations further include processing the trained unsupervised clustering pipelines to generate internal scores and external scores for the set of clustering datasets, creating an encoded clustering pipeline by encoding the trained clustering pipeline using the external score as a label and generating a trained supervised machine learning model by combining the internal scores and the encoded clustering pipelines.

In some examples of the computer program product, the classification datasets include unseen datasets, and creating a set of clustering datasets includes creating a repository of labeled datasets, wherein the labeled datasets are used to match a clustering pipeline with a particular labeled dataset.

In yet further examples of the computer program product, processing includes generating a plurality of selected top k clustering pipelines by identifying a plurality of top k clustering pipelines from a plurality of k clustering pipelines.

In yet further examples of the computer program product, processing further includes executing the plurality of selected top k clustering pipelines to obtain the internal scores, wherein the selected top k clustering pipelines are encoded and combined with the internal scores to generate an input to the machine learning clustering meta learning model.

In yet further examples of the computer program product, the internal scores include a silhouette_score, a calinski_harabasz_score and a davies_bouldin_score, and wherein the external scores include a normalized_mutual_info_score, a fowlkes_mallows_score and an adjusted_rand_score.

In yet further examples of the computer program product, generating a trained supervised machine learning model includes generating an encoded trained clustering pipeline by encoding the trained clustering pipeline with the external score as a label and combining the encoded trained clustering pipe with the internal scores.

As discussed briefly above, clustering is an unsupervised machine learning method of identifying and grouping similar data points of larger datasets without concern for a specific outcome. Currently, there are a variety of clustering analysis tools available online to help solve clustering problems. Unfortunately, one problem with the available clustering analysis tools is that while the available analysis methods are great at separating data into subsets, the strategies used beyond that point are usually not related to the data itself, but rather related to the positioning of the data in relation to other data points of the dataset. Therefore, one of the biggest issues with solving clustering problems includes the problem of clustering the partition data samples into groups of similar data and not simply into groups of data that are relative to other data points of the subset. Currently, all of the clustering data problem solution methods attempt to solve clustering problems by utilizing an unsupervised approach. Moreover, although different available clustering algorithms work well on different data sets, this lack of supervision makes it difficult to match a specific clustering algorithm with a specific data set.

An embodiment of the invention involves generating a Meta Learning Model (MLM) that outputs a “best clustering pipeline” (e.g., the pipeline is in the form of imputation, scaling, feature engineering, clustering estimator, etc.) for an unseen dataset. The method includes creating a repository of labeled data sets that is used to learn which type of pipeline matches a particular data set and the MLM is used to select an appropriate clustering pipeline for the unseen dataset. It should be appreciated that the MLM outputs different clustering pipelines for different input unseen data sets, thereby offering a robust and efficient solution for clustering. The invention involves converting an unsupervised problem into a supervised problem by creating clustering datasets for meta learning from supervised datasets, where the representation is at the dataset level and where each row in the supervised dataset corresponds to a pipeline-repository dataset combination. The internal scores and the external scores are then combined to formulate a regression problem for predicting the best clustering pipelines.

In accordance with an embodiment, the invention includes a method for building an MLM for solving the clustering problem in a supervised manner. The method includes creating a large, diverse dataset repository from classification datasets and using target labels as cluster labels. Clustering pipelines are created in the form of [imputation, scaling, feature engineering, clustering estimator], where the clustering estimators may include Optis, DBScan, Agglomerative, Birch, GaussianMixture, MeanShift, MiniBatch, Spectral, etc. The clustering pipelines are then trained on the clustering datasets. Additionally, the method includes computing the clustering internal measures such as silhouette_score, calinski_harabasz_score, and davies_bouldin_score, wherein the internal score does not need ground truth cluster labels. The clustering external score is computed, such as normalized_mutual_info_score, which needs predicted cluster labels and the ground truth cluster labels that were recently computed.

At this point, a supervised learning problem is formulated, where the problem includes internal scores and pipeline on-hot encoding and the external score computed above. The first supervised predictive model (e.g., MLM) is trained to predict the external score and the top k clustering pipelines are selected as new features of the MLM. The final supervised predictive model (MLM) is then trained, where the model includes the internal scores, the top k clustering pipeline encoding and the external scores. The best clustering pipelines (i.e., those having the highest predicted external score) for an unseen dataset is then predicted using the final supervised predictive model (MLM).

In an embodiment, the method of the invention converts an unsupervised learning problem (i.e., clustering) into a supervised learning problem (i.e., regression) and solves the learning problem in a stepwise fashion. The method of the invention builds a regression model for predicting an external score by automating the creation of a large, diverse dataset repository having ground truth cluster labels (or IDs). The method then involves transforming the datasets with a diverse subset of clustering pipelines into a representation consisting of internal scores from the selected clustering pipelines. The internal score representation of the diverse subset of the datasets are concatenated and the clustering pipelines are encoded to create a training dataset. The training dataset and the ground truth clusters labels of the external score are used to train the first supervised learning regression model to predict the external score for each clustering pipeline. The method further involves selecting the top k most important clustering pipelines from this first MLM and training the second (and final) MLM with the internal scores and encoding the selected top k clustering pipelines.

The method further includes deploying the trained classification model on a new dataset by generating the internal score representation for the new dataset, encoding selected top k clustering pipelines and concatenating the internal scores and encoded clustering pipelines to form a test dataset. The method includes predicting the external scores for the test dataset with the trained classification model and returning the best clustering pipeline having the highest predicted external score. The returned clustering pipeline is then used to assign clustering labels to samples of the new dataset.

In accordance with an embodiment, one example of illustrating the method of creating a machine learning clustering meta learning model for use in solving a machine learning clustering problem is shown where multi-classification datasets from OpenML were downloaded and clustering datasets were created. This was accomplished by selecting a subset of class labels in the originally downloaded multi-classification dataset and all of the samples that belong to the subset of class labels. Using one of the originally downloaded multi-classification dataset, multiple non-overlapping datasets with ground truth cluster label (i.e. class labels of the originally downloaded multi-classification dataset) were derived which created 1098 clustering datasets. Diverse clustering pipelines were then created by initially creating multiple compatible clustering pipelines using an open-source library, such as SKLearn, where the compatible clustering pipelines are comprised of multiple stages including an imputation stage, a scaling stage, a feature engineering stage, and an estimator stage.

The imputation stage includes an Iterative Imputer which is an estimator that fills in missing values of a dataset and the scaling stage includes a Standard Scaler which scales the data using the mean and standard deviation of the dataset. The feature engineering stage transforms selected features of a dataset to create certain patterns, to provide insight and to improve understanding of the dataset. The feature engineering stage includes a PassthroughTransformer, Polynomial Features and t-SNE, where t-SNE focuses on the local structure of the dataset and extracts clustered local groups of samples. The estimator stage is an object that fits a model based on some training data and that is capable of inferring some properties on new data to implement a fit method fit(X, y), where the estimator stage includes an agglomerative estimator, a birch estimator, a GaussianMixture estimator, a MeanShift estimator, a MiniBatch estimator and a Spectral estimator, each of which includes tens of hyperparameters. This created 280 clustering pipelines corresponding to the above stages.

At this point, a supervised dataset having internal scores, Pipeline encoding and external scores is generated by training a supervised model that predicts performance of clustering pipelines on clustering datasets. The trained supervised model is used to predict cluster labels and to score the datasets. This resulted in 290 k datasets. The internal scores (silhouette_score, calinski_harabasz_score, davies_bouldin_score) and external score (normalized_mutual_info_score) is calculated for each of these 290 k datasets. The 280 clustering pipelines were one-hot encoded and the scores and encoding were concatenated resulting in a matrix (290 k, 284), where X=(290K, 283), y=(290 k, 1), y is the external score. The matrix (X, y) is then split into a train/validation/test split having a ratio of 80/10/10, to create a neural network that generalizes well to new data. The method further includes training a Regression Model as a Meta Learning Model, where the input is the matrix (X, y), where X=(232000, 283) and y=(232000, 1) and the output is a trained regression model that predicts the external score. This may be accomplished by performing feature selection on X to train an XGB model (where an XGB model is a supervised learning algorithm that is used to make predictions on continuous numerical data) and to use the feature importance calculated by the model and then take the top 20 most important pipeline features to form a matrix X1=(232000, 23), where the internal scores are always included in the matrix X1. The second XGB regression model is then trained on matrix (X1, y), where the output is the trained XGB model and the top 20 pipelines to be used at test time.

The method also includes performing clustering for unseen datasets, where the input is a dataset and the output is the cluster label assignment for each row in the input dataset. This may be accomplished by selecting the top 20 pipelines using the XGB meta learner and, for each of these top 20 pipelines, computing a feature vector of three (3) internal features (silhouette_score, calinski_harabasz_score, davies_bouldin_score) of the pipeline, creating a one-hot encoding vector of length 20, where the value of 1 corresponds to the position of the pipeline in a list of the 20 pipelines and concatenating these two vectors, creating a vector of 23 elements. The best pipeline out of these pipeline is determined by creating the Xtest of shape: (20, 23), scoring the Xtest Using the XGB meta learner and receiving the ypred vector of 20 elements, identifying the row in the Xtest that has the highest prediction score and identifying the pipeline corresponding to that row and selecting that pipeline as the best pipeline. Lastly, the selected best pipeline is used to assign cluster labels for samples in the input dataset.

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as for solving a machine learning clustering problem using a machine learning clustering meta learning model, as shown at block 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

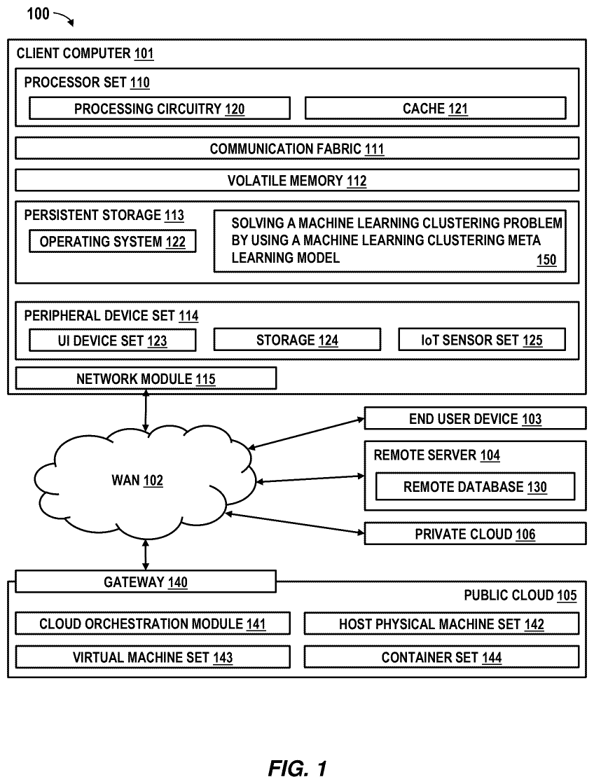

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collects and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

One or more embodiments described herein can utilize machine learning techniques to perform tasks. More specifically, one or more embodiments described herein can incorporate and utilize rule-based decision making and artificial intelligence (AI) reasoning to accomplish the various operations described herein, namely containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

ANNs can be embodied as so-called “neuromorphic” systems of interconnected processor elements that act as simulated “neurons” and exchange “messages” between each other in the form of electronic signals. Similar to the so-called “plasticity” of synaptic neurotransmitter connections that carry messages between biological neurons, the connections in ANNs that carry electronic messages between simulated neurons are provided with numeric weights that correspond to the strength or weakness of a given connection. The weights can be adjusted and tuned based on experience, making ANNs adaptive to inputs and capable of learning. For example, an ANN for handwriting recognition is defined by a set of input neurons that can be activated by the pixels of an input image. After being weighted and transformed by a function determined by the network's designer, the activation of these input neurons are then passed to other downstream neurons, which are often referred to as “hidden” neurons. This process is repeated until an output neuron is activated. The activated output neuron determines which character was input. It should be appreciated that these same techniques can be applied in the case of containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

In accordance with an embodiment and as discussed hereinabove, consider the example problem where there are 280 clustering pipelines and 1098 clustering datasets. For each clustering pipeline/dataset pair, the internal scores (i.e., silhouette_score, calinski_harabasz_score, davies_bouldin_score) and the external score (normalized_mutual_info_score) was calculated. The 280 pipelines were then encoded using one-hot encoding which results in a feature space X having 283 features (i.e., 280 pipelines plus 3 internal scores), where the feature space X has the shape of (290 k, 283). The external score (i.e., normalized_mutual_info_score) is designated as Target y, where Target y has the shape of (290 k, 1). The dataset (X, y) is then formulated as a regression problem and an XGB model is trained as a metalearner on X to predict y. Feature engineering is performed to select the most important 20 features in X to reduce the size of X to a more manageable sample size. A final XGB metalearner is then trained to predict y from the size reduced X. The pipelines having the top k predicted values are then identified.

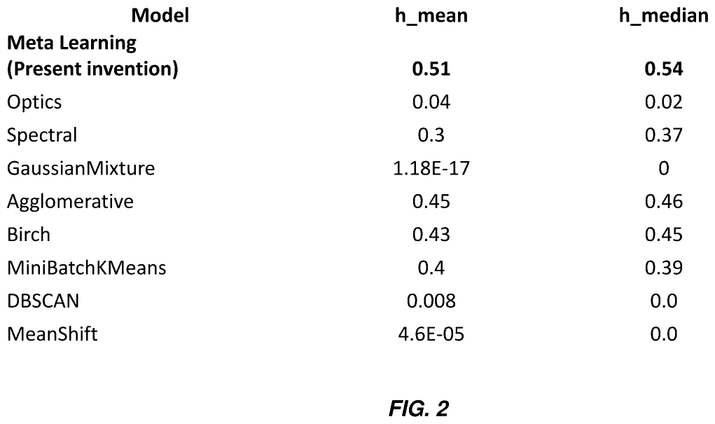

The method then evaluates the XGB metalearner on 272 unseen clustering datasets. It should be appreciated that other SKLearn clustering algorithms may also be evaluated on the same 272 clustering datasets, where a metric used to compare the performance among these clustering algorithms is clustering purity (i.e., homogeneity). A result of this comparison is shown in FIG. 2, where the results demonstrate that the method of the invention outperforms all of the currently existing SKLearning clustering algorithms.

It should be appreciated that for an unseen dataset, in order to be able to use the trained XGB metalearner, at least 20 pipelines should be run to create the feature vector for the XGB meta learner. Although it takes longer for meta learning to find the clusters, it achieves a much better cluster purity as demonstrated in FIG. 2. The challenge for clustering is that at test time, there are no cluster labels to compare against. Thus, the method converts a clustering problem into a regression problem (with labels) and identifies the best clustering pipelines for an unseen data set, where the focus is on performance rather than run time. Moreover, the internal metrics are calculated using the clustering results of the clustering pipeline, where the internal metrics are used to improve performance with respect to the external metrics. For example, one internal metric may be the mean square distance of the dataset points from their clustering centroids.

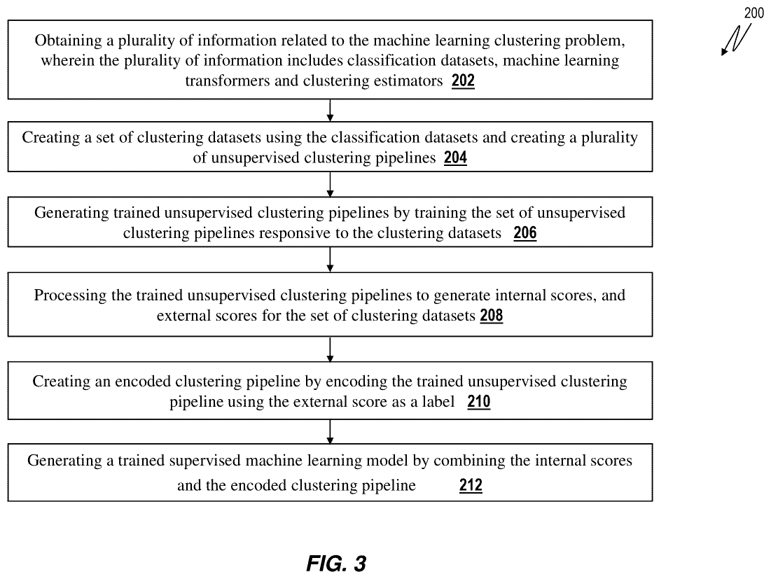

In accordance with an embodiment and referring to FIG. 3, a method 200 of creating a machine learning clustering meta learning model to solve a machine learning clustering problem is provided and includes obtaining a plurality of information related to the machine learning clustering problem, as shown in operational block 202, where the plurality of information may include classification data sets, machine learning transformers and clustering estimators. The method 200 includes creating a set of clustering datasets using the classification datasets, as shown in operational block 204, and creating a set of unsupervised clustering pipelines using the machine learning transformers and clustering estimators, as shown in operational block 206. In an embodiment, the unsupervised clustering pipelines may have an estimation stage and one or more other stages, including an imputation stage, a scaling stage and a feature engineering stage. In accordance with an embodiment, as discussed hereinabove, some of the clustering estimators that may be used for this task may include an Optis estimator, a DBScan estimator, an Agglomerative estimator, a Birch estimator, a GaussianMixture estimator, a MeanShift estimator, a MiniBatch estimator and a Spectral estimator.

The method 200 further includes training the set of unsupervised clustering pipelines responsive to the clustering datasets, as shown in operational block 208. These trained pipelines are then processed to generate internal scores and external scores for the set of clustering datasets, as shown in operational block 210. This may be accomplished by, at the time of testing, executing all of the selected top k clustering pipelines on unseen datasets to obtain the internal scores, where the internal scores are combined with encoding of the top k clustering pipelines thereby forming the input for the trained meta learning model. The internal scores may include a silhouette_score, a calinski_harabasz_score and a davies_bouldin_score and the external score may include a normalized_mutual_info_score, a fowlkes_mallows_score and an adjusted_rand_score. In an embodiment, the trained meta learning model (i.e., the supervised model) may then predict the external score given the internal scores and the clustering pipeline encoding.

The method includes generating a supervised model, as shown in operational block 212, where the supervised model may be generated by combining the internal scores and by encoding the clustering pipelines with the external score as a label. The predicted external score can be used to find the clustering pipeline with the highest predicted external score (e.g., the ‘best’ clustering pipeline). It should be appreciated that, in an embodiment, feature selection may be performed on the supervised dataset using a tree based predictive model like XGB, Random Forest, or a Feature Transformation model like PCA, Gaussian Random Projection and Mahalanobis distance transformation. Moreover, the encoding of the clustering pipeline may be accomplished via a one-hot encoding method which is used to represent categorical variables as numerical values in a machine learning model. The method further includes generating and training a supervised machine learning model for predicting the best clustering models for the clustering datasets. Additionally, in an embodiment, the selected clustering model or clustering pipeline by the meta learning model may be used to assign cluster labels (i.e., ids) to samples of the unseen dataset at the time of testing.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description, but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein. Moreover, the embodiments or parts of the embodiments may be combined in whole or in part without departing from the scope of the invention.

What is claimed is:

1. A method of creating a machine learning clustering meta learning model for use in solving a machine learning clustering problem, the method comprising:
obtaining a plurality of information related to the machine learning clustering problem, wherein the plurality of information includes classification datasets, machine learning transformers and clustering estimators;
creating a set of clustering datasets using the classification datasets, and creating a plurality of unsupervised clustering pipelines;
generating trained unsupervised clustering pipelines by training the set of unsupervised clustering pipelines responsive to the clustering datasets;
processing the trained unsupervised clustering pipelines to generate internal scores and external scores for the set of clustering datasets;
creating an encoded clustering pipeline by encoding the trained clustering pipeline using the external score as a label; and
generating a trained supervised machine learning model by combining the internal scores and the encoded clustering pipelines.

2. The method of claim 1, wherein the classification datasets include unseen datasets.

3. The method of claim 1, wherein creating a set of clustering datasets includes creating a repository of labeled datasets, wherein the labeled datasets are used to match a clustering pipeline with a particular labeled dataset.

4. The method of claim 1, wherein processing includes generating a plurality of selected top k clustering pipelines by identifying a plurality of top k clustering pipelines from a plurality of k clustering pipelines.

5. The method of claim 4, wherein processing includes executing the plurality of selected top k clustering pipelines to obtain the internal scores, wherein the selected top k clustering pipelines are encoded and combined with the internal scores to generate an input to the machine learning clustering meta learning model.

6. The method of claim 1, wherein the internal scores include a silhouette_score, a calinski_harabasz_score and a davies_bouldin_score, and wherein the external scores include a normalized_mutual_info_score, a fowlkes_mallows_score and an adjusted_rand_score.

7. The method of claim 1, wherein generating a trained supervised machine learning model includes generating an encoded trained clustering pipeline by encoding the trained clustering pipeline with the external scores as a label and combining the encoded trained clustering pipe with the internal scores.

8. A computing system, comprising:
a processor configured to perform operations for creating a machine learning clustering meta learning model for use in solving a machine learning clustering problem, the operations comprising:
obtaining a plurality of information related to the machine learning clustering problem, wherein the plurality of information include classification datasets, machine learning transformers and clustering estimators;
creating a set of clustering datasets using the classification datasets, and creating a plurality of unsupervised clustering pipelines;
generating trained unsupervised clustering pipelines by training the set of unsupervised clustering pipelines responsive to the clustering datasets;
processing the trained unsupervised clustering pipelines to generate internal scores and external scores for the set of clustering datasets;
creating an encoded clustering pipeline by encoding the trained clustering pipeline using the external score as a label; and
generating a trained supervised machine learning model by combining the internal scores and the encoded clustering pipelines.

9. The computing system of claim 8, wherein the classification datasets include unseen datasets.

10. The computing system of claim 8, wherein creating a set of clustering datasets includes creating a repository of labeled datasets, wherein the labeled datasets are used to match a clustering pipeline with a particular labeled dataset.

11. The computing system of claim 8, wherein processing includes generating a plurality of selected top k clustering pipelines by identifying a plurality of top k clustering pipelines from a plurality of k clustering pipelines.

12. The computing system of claim 11, wherein processing includes executing the plurality of selected top k clustering pipelines to obtain the internal scores, wherein the selected top k clustering pipelines are encoded and combined with the internal scores to generate an input to the machine learning clustering meta learning model.

13. The computing system of claim 8, wherein the internal scores include a silhouette_score, a calinski_harabasz_score and a davies_bouldin_score, and wherein the external scores include a normalized_mutual_info_score, a fowlkes_mallows_score and an adjusted_rand_score.

14. The computing system of claim 8, wherein generating a trained supervised machine learning model includes generating an encoded trained clustering pipeline by encoding the trained clustering pipeline with the external scores as a label and combining the encoded trained clustering pipe with the internal scores.

15. A computer program product comprising a computer readable storage medium having program instructions embodied therewith, the program instructions executable by a processor to cause the processor to perform operations for creating a machine learning clustering meta learning model for use in solving a machine learning clustering problem, the operations comprising:
obtaining a plurality of information related to the machine learning clustering problem, wherein the plurality of information includes classification datasets, machine learning transformers and clustering estimators;
creating a set of clustering datasets using the classification datasets, and creating a plurality of unsupervised clustering pipelines;
generating trained unsupervised clustering pipelines by training the set of unsupervised clustering pipelines responsive to the clustering datasets;
processing the trained unsupervised clustering pipelines to generate internal scores and external scores for the set of clustering datasets;
creating an encoded clustering pipeline by encoding the trained clustering pipeline using the external score as a label; and
generating a trained supervised machine learning model by combining the internal scores and the encoded clustering pipelines.

16. The computer program product of claim 15, wherein
the classification datasets include unseen datasets, and
creating a set of clustering datasets includes creating a repository of labeled datasets, wherein the labeled datasets are used to match a clustering pipeline with a particular labeled dataset.

17. The computer program product of claim 15, wherein processing includes generating a plurality of selected top k clustering pipelines by identifying a plurality of top k clustering pipelines from a plurality of k clustering pipelines.

18. The computer program product of claim 17, wherein processing includes executing the plurality of selected top k clustering pipelines to obtain the internal scores, wherein the selected top k clustering pipelines are encoded and combined with the internal scores to generate an input to the machine learning clustering meta learning model.

19. The computer program product of claim 15, wherein the internal scores include a silhouette_score, a calinski_harabasz_score and a davies_bouldin_score, and wherein the external scores include a normalized_mutual_info_score, a fowlkes_mallows_score and an adjusted_rand_score.

20. The computer program product of claim 15, wherein generating a trained supervised machine learning model includes generating an encoded trained clustering pipeline by encoding the trained clustering pipeline with the external scores as a label and combining the encoded trained clustering pipe with the internal scores.
